(19) United States
(12) Patent Application Publication
(10) Pub. No.: US 2026/0015801 A1
(43) Pub. Date: Jan. 15, 2026

(54) MOULDING OF HOLLOW MOULDED FIBRE PRODUCTS

(71) Applicant: Pulpex Limited, Sawston (GB)

(72) Inventor: Daniel George PROZESKY, Sawston (GB)

(21) Appl. No.: 19/327,708

(22) Filed: Sep. 12, 2025

Related U.S. Application Data
(63) Continuation of application No. PCT/GB2024/050605, filed on Mar. 7, 2024.

(30) Foreign Application Priority Data
Mar. 14, 2023 (GB) 2303750.0

(51) Int. Cl. D21J 7/00; B29C 33/38

(52) U.S. Cl. CPC D21J 7/00; B29C 33/3814; B29C 33/3842

(57) ABSTRACT

A mould for further moulding a hollow moulded fibre product, the mould comprising: one or more internal surfaces together defining a cavity, within which the further moulding is carried out, the one or more internal surfaces comprising one or more porous regions that extend over at least the majority of the total internal area of the cavity; a plurality of pores; and a transport system configured to bring the hollow moulded fibre product into operative engagement with the mould for the further moulding. The pores are distributed over the porous regions to provide continuous porosity over them, and have an average pore size of less than or equal to 90 μm. Also provided is a moulding system comprising such a mould, a method of making such a mould, and a method of providing a processed hollow moulded fibre product using such a mould.

### CROSS-REFERENCE TO RELATED APPLICATIONS

This application is a continuation under 35 U.S.C. § 120 of International Application No. PCT/GB2024/050605, filed Mar. 7, 2024, which claims priority to United Kingdom Application No. GB 2303750.0, filed Mar. 14, 2023 under 35 U.S.C. § 119 (a). Each of the above-referenced patent applications is incorporated by reference in its entirety.

### TECHNICAL FIELD

The present invention relates to methods and systems for manufacturing receptacles from a fibre suspension, such as a fibre suspension comprising paper pulp. The receptacles may be consumer packaging, such as bottles, jars or certain types of vases, useful for holding liquids, powders, other flowable materials, one or more solid objects, or a combination thereof.

### BACKGROUND

It is desirable to reduce glass and plastics use in consumable items, particularly packaging. Non-necked receptacles, such as trays, bowls and other simple shapes, are commonly made from paper pulp. However, a more complex necked receptacle, like a bottle, jar or certain types of vase, is more difficult to engineer due to an internal narrowing of the receptacle between a main body portion of the receptacle and an opening of the receptacle.

Various approaches are known for manufacturing receptacles from fibre suspensions. A number of such approaches involve the moulding of a hollow moulded fibre product, which may be further processed in order to provide a finished receptacle. In particular, such further processing may comprise carrying out an additional moulding process on the hollow moulded fibre product to further mould its shape. For instance, such further moulding may be used to achieve a desired neck and surface finish, such as, for example, embossed and/or debossed surface features. The further moulding may also (or instead) increase the rigidity and/or robustness of the hollow moulded fibre product, for example by compacting the hollow moulded fibre product and/or by removing liquid/moisture from it. However, issues remain with such further moulding processes, for example in terms of achieving a suitable quality level for the hollow moulded fibre product and/or achieving a suitable level of throughput for the further moulding process.

### SUMMARY

To mitigate the issues identified above relating to achieving a suitable quality level for the hollow moulded fibre product and/or a suitable level of throughput for the further moulding process, and/or to mitigate other issues connected with the further moulding of hollow moulded fibre products, the inventors propose to utilise a mould for such further moulding that comprises a plurality of pores having an average pore size of less than or equal to 90 μm, with such pores being distributed over one or more porous regions of a cavity of the mould to provide continuous porosity over such porous regions. The inventors consider that a mould with pores having an average pore size of less than or equal to 90 μm may provide a suitable quality level for the hollow moulded fibre product after further moulding, including, for example, a relatively smooth surface on the hollow moulded fibre product. Moreover, where such pores are distributed over one or more porous regions of the mould cavity to provide continuous porosity over such porous regions, with such porous regions extending over at least a majority of the total internal area of the mould cavity, such pores provide a suitable venting of moisture and/or vapor from the cavity of the mould during further moulding of the hollow moulded fibre product. Such venting may reduce (or remove) the need to carry out additional drying of the hollow moulded fibre product, thus increasing throughput for the further moulding process. The inventors further consider that the continuous porosity provided by the pores may assist in achieving a suitable quality level for the hollow moulded fibre product. This is, for example, because large discontinuities in drying speeds between different regions of the hollow moulded fibre product can be avoided. The inventors consider that such discontinuities in drying speeds could otherwise lead to the different regions contracting at significantly different rates, increasing the risk that the product warps during further moulding.

Therefore, according to a first aspect of the present invention, there is provided a moulding system for providing a processed hollow moulded fibre product, the system comprising: a mould for further moulding a hollow moulded fibre product to provide the processed hollow moulded fibre product, the mould comprising: one or more internal surfaces that together define a cavity, within which the further moulding of the hollow moulded fibre product is carried out, during use of the system, the cavity having a total internal area and the one or more internal surfaces comprising one or more porous regions that extend over at least a majority of the total internal area; a plurality of pores, the pores being distributed over the one or more porous regions to provide continuous porosity over the one or more porous regions, the pores having an average pore size of less than or equal to 90 μm; and a transport system configured to bring the hollow moulded fibre product into operative engagement with the mould for the further moulding.

A mould having an average pore size that is less than or equal to 90 μm has been found to provide a relatively smooth surface on the hollow moulded fibre product after further moulding, while also providing sufficient venting of fluid, such as vapor or liquid (e.g., steam or water), from the cavity of the mould during such further moulding of the hollow moulded fibre product.

Optionally, the system further comprises: a primary mould comprising a cavity; and a fibre suspension supply system, which is configured to deposit a volume of the fibre suspension within the cavity of the primary mould, so that the volume of the fibre suspension is thereby mouldable by the cavity of the primary mould into the hollow moulded fibre product. In examples, the primary mould is arranged upstream of the mould for further moulding the hollow moulded fibre product. Additionally or alternatively, the transport system may be configured to transport the hollow moulded fibre product from the primary mould into operative engagement with the mould for further moulding the hollow moulded fibre product.

Optionally, the system further comprises a heating system for heating the hollow moulded fibre product during the further moulding of the hollow moulded fibre product by the mould. In examples, the heating system comprises a heater that is operable to heat the mould, which in turn heats the hollow moulded fibre product (e.g., by conductive heat transfer). In such examples, the mould may be described as a thermoforming mould. As an alternative (or in addition), the heating system may be configured to supply a heated fluid to the interior of the hollow moulded fibre product.

Optionally, the system further comprises a pressuring system for applying pressure to an interior of the hollow moulded fibre product during the further moulding of the hollow moulded fibre product by the mould, so as to press an exterior of the hollow moulded fibre product against the one or more internal surfaces of the mould. In examples, the pressuring system comprises an expandable element, such as an inflation element, which the pressuring system is configured to expand during the further moulding of the hollow moulded fibre product by the mould, so that an exterior of the expandable element is pressed against the interior of the hollow moulded fibre product, the pressuring system thereby applying pressure to the interior of the hollow moulded fibre product.

According to a second aspect of the present invention there is provided a method of providing a processed hollow moulded fibre product, the method comprising: introducing a hollow moulded fibre product into a mould, the mould comprising: one or more internal surfaces that together define a cavity having a total internal area, the one or more internal surfaces comprising one or more porous regions that extend over at least a majority of the total internal area; a plurality of pores, the pores being distributed over the one or more porous regions to provide continuous porosity over the one or more porous regions, the pores having an average pore size of less than or equal to 90 μm; and further moulding the hollow moulded fibre product within the cavity of the mould so as to provide the processed hollow moulded fibre product.

Further moulding a hollow moulded fibre product using a mould having an average pore size that is less than or equal to 90 μm has been found to provide a relatively smooth surface on the hollow moulded fibre product, while also providing sufficient venting of fluid, such as vapor or liquid (e.g., steam or water), from the cavity of the mould during such further moulding of the hollow moulded fibre product.

In examples, during the further moulding of the hollow moulded fibre product, fluid (such as vapor or liquid, e.g., steam or water) leaves the cavity of the mould through the plurality of pores. The fluid may thereafter pass through and out of the mould, via an exterior surface thereof.

Optionally, the further moulding of the hollow moulded fibre product within the cavity of the mould so as to provide the processed hollow moulded fibre product comprises at least one of: moving the mould into a closed arrangement with the hollow moulded fibre product within the cavity of the mould; and pressing an exterior of the hollow moulded fibre product against the one or more internal surfaces of the mould.

Optionally, the further moulding of the hollow moulded fibre product within the cavity of the mould so as to provide the processed hollow moulded fibre product comprises heating the hollow moulded fibre product. In examples, the heating of the hollow moulded fibre product comprises heating the mould. In such examples, the mould may, in turn, heat the hollow moulded fibre product (e.g., by conductive heat transfer). Alternatively (or additionally), the heating of the hollow moulded fibre product may comprise introducing a heated fluid to the interior of the hollow moulded fibre product. In examples where the further moulding of the hollow moulded fibre product of comprises pressing an exterior of the hollow moulded fibre product against the one or more internal surfaces of the mould, the heating of the hollow moulded fibre product may occur during the pressing of the exterior of the hollow moulded fibre product against the one or more internal surfaces of the mould.

In examples where the further moulding of the hollow moulded fibre product of comprises pressing an exterior of the hollow moulded fibre product against the one or more internal surfaces of the mould, the pressing the exterior of the hollow moulded fibre product against the one or more internal surfaces of the mould comprises applying pressure to the interior of the hollow moulded fibre product. In particular examples, the applying pressure to the interior of the hollow moulded fibre product comprises expanding an inflation element, so that an exterior of the inflation element is pressed against the interior of the hollow moulded fibre product.

According to a third aspect of the present invention there is provided a mould for further moulding a hollow moulded fibre product that has been brought into operative engagement with the mould by a transport system, to provide a processed hollow moulded fibre product, the mould comprising: one or more internal surfaces that together define a cavity, in which the further moulding of the hollow moulded fibre product is carried out during use of the mould, the cavity having a total internal area, the one or more internal surfaces comprising one or more porous regions that extend over at least a majority of the total internal area; and a plurality of pores, the pores being distributed over the one or more porous regions to provide continuous porosity over the one or more porous regions, the pores having an average pore size of less than or equal to 90 μm.

Further moulding a hollow moulded fibre product using a mould having an average pore size that is less than or equal to 90 μm has been found to provide a relatively smooth surface on the hollow moulded fibre product, while also providing sufficient venting of fluid, such as vapor or liquid (e.g., steam or water), from the cavity of the mould during such further moulding of the hollow moulded fibre product.

In examples, the mould is a thermoforming mould. Hence (or otherwise), the mould may comprise or be connectable to a heater.

According to a fourth aspect of the present invention there is provided a method of making a mould for further moulding a hollow moulded fibre product that has been brought into operative engagement with the mould by a transport system, the mould comprising: one or more internal surfaces that together define a cavity, in which the further moulding of the receptacle is carried out during use of the mould, the cavity having a total internal area, the one or more internal surfaces comprising one or more porous regions that extend over at least a majority of the total internal area; and a plurality of pores, the pores being distributed over the one or more porous regions to provide continuous porosity over the one or more porous regions, the pores having an average pore size of less than or equal to 90 μm, the method comprising: forming the mould in one or more pieces.

Optionally, the forming of the mould in one or more pieces comprises additively manufacturing the one or more pieces. In examples, the additively manufacturing of the one or more pieces comprises receiving data defining a three-dimensional shape for each of the one or more pieces. In addition, or instead, the additively manufacturing of the one or more pieces comprises sintering particulate matter. In examples, the particulate matter is metallic.

Optionally, the forming of the mould in one or more pieces comprises machining at least one piece of a porous material. As used herein, machining refers to the use of a subtractive manufacturing process. In examples, the porous material is metallic, such as porous aluminium or porous aluminium alloy, or porous stainless steel. In some examples, the machining may be under the control of a computer, and may, for example, comprise receiving, at the computer, data defining a three-dimensional shape for each of the one or more pieces.

In some examples of the systems, methods and moulds disclosed herein, the average pore size is less than or equal to 80 μm, whereas in other examples the average pore size is less than or equal to 70 μm, and in still other examples the average pore size is less than or equal to 60 μm. In yet further examples, the average pore size is less than or equal to 50 μm and in still other examples the average pore size is less than or equal to 40 μm. In still further examples, the average pore size is less than or equal to 30 μm, and in still other examples the average pore size is less than or equal to 20 μm.

In some examples of the systems, methods and moulds disclosed herein, the average pore size is greater than or equal to 10 μm. This may provide a relatively high level of venting of moisture and/or vapor from the cavity to an exterior of the mould 125 during further moulding of the hollow moulded fibre product. Nevertheless, in certain examples, the average pore size could instead be less than or equal to 10 μm.

In examples of the systems, methods and moulds disclosed herein, the mould for further moulding the hollow moulded fibre product comprises aluminium in an amount that is at least Y %, by weight, of a total weight of the mould, wherein Y is 50%. In some examples, Y is 60%, in other examples 70%, in still other examples 80%, and in yet further examples 90%.

In other examples of the systems, methods and moulds disclosed herein, the mould for further moulding the hollow moulded fibre product comprises stainless steel in an amount that is at least Y %, by weight, of a total weight of the mould, wherein Y is 50%. In some examples, Y is 60%, in other examples 70%, in still other examples 80%, and in yet further examples 90%.

In some examples of the systems, methods and moulds disclosed herein, each of the pores has a circular cross-sectional shape in a plane orthogonal to a central axis of the pore. Each of the pores may therefore be considered circular.

According to a fifth aspect of the present invention there is provided a control system configured to cause a moulding system to perform the method of any one of the examples disclosed herein of providing a processed hollow moulded fibre product.

A non-transitory storage medium storing machine-readable instructions that, when executed by a processor of a controller for a moulding system, cause the moulding system to perform the method of any one of the examples disclosed herein of providing a processed hollow moulded fibre product.

In some examples of the above aspects, the one or more porous regions extend over at least 60% of the total internal area. In other examples they extend over at least 70% of the total internal area.

In some examples of any of the above aspects, the processed hollow moulded fibre product is a necked hollow moulded fibre product, such as a bottle, a jar or a type of vase. In some examples of any of the above aspects, the processed hollow moulded fibre product is a bottle.

According to a sixth aspect of the present invention there is provided a receptacle manufacturing line comprising the moulding system according to any one of the examples disclosed herein for providing the processed hollow moulded fibre product, and apparatus for performing at least one additional process on the processed hollow moulded fibre product to provide the receptacle.

The apparatus may comprise an interior coater and the at least one additional process may comprise the interior coater coating at least a portion of an interior of the product to produce an internally coated product. The apparatus may comprise a closure-part applicator and the at least one additional process may comprise the closure-part applicator applying a closure part to the product or the internally coated product to produce a closable or closed product. The apparatus may comprise an exterior coater and the at least one additional process may comprise the exterior coater coating at least a portion of an exterior of the product or the internally coated product or the closable or closed product to produce an externally coated product. The apparatus may comprise a decorator and the at least one additional process may comprise the decorator decorating the product or the internally coated product or the closable or closed product or the externally coated product to produce a decorated product. The apparatus may comprise a dryer and the at least one additional process may comprise the dryer drying the product or the internally coated product or the closable or closed product or the externally coated product or the decorated product to produce a dried product. The apparatus may comprise an evaluator and the at least one additional process may comprise the evaluator evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase, and the receptacle manufacturing line is a necked-receptacle manufacturing line. In some examples, the receptacle is a bottle.

According to a seventh aspect of the present invention there is provided a method of manufacturing a receptacle, the method comprising performing the method of providing a processed hollow moulded fibre product according to any one of the examples disclosed herein to provide the processed hollow moulded fibre product, and then performing at least one additional process on the processed hollow moulded fibre product to provide the receptacle.

The at least one additional process may comprise coating at least a portion of an interior of the product to produce an internally coated product. The at least one additional process may comprise applying a closure part to the product or the internally coated product to produce a closable or closed product. The at least one additional process may comprise coating at least a portion of an exterior of the product or the internally coated product or the closable or closed product to produce an externally coated product. The at least one additional process may comprise decorating the product or the internally coated product or the closable or closed product or the externally coated product to produce a decorated product. The at least one additional process may comprise drying the product or the internally coated product or the closable or closed product or the externally coated product or the decorated product to produce a dried product. The at least one additional process may comprise evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase. In some examples, the receptacle is a bottle.

According to an eighth aspect of the present invention there is provided a method of providing a content-containing receptacle, the method comprising: providing a receptacle obtained by the method of any of the examples of the eighth aspect of the invention; and providing contents in the receptacle to provide the content-containing receptacle.

In some examples, the providing the contents in the receptacle comprises putting the contents into the receptacle. In contrast, in some examples, the providing the receptacle comprises providing the receptacle with the contents already present in the receptacle, thereby providing the contents in the receptacle.

The contents may be in the form of, for example, a liquid, a powder, other flowable materials, one or more solid objects, or a combination thereof. For example, the contents may be a foodstuff such as a condiment, a beverage such as an alcoholic beverage, a household care product such as a detergent or other cleaning product, a personal care product such as a hair care product or a personal cleansing product or a healthcare product or a pharmaceutical product or a cosmetics product, a fragrance product such as a perfume, a vehicle product such as motor oil, or an industrial product. Other suitable contents will be apparent to the skilled reader in view of the content of this application and their common general knowledge.

In some examples, the receptacle is a necked receptacle, such as a bottle, a jar or a type of vase. In some examples, the receptacle is a bottle.

Optionally, the method comprises: closing an opening of the receptacle after the providing contents in the receptacle, and/or applying a label or indicia to the receptacle. In some examples, the closing comprises applying a closure (such as a lid or a cap or a heat seal) to the receptacle to close the opening. In some examples, the closing comprises applying a heat seal to the receptacle and (e.g., thereafter) applying a lid or a cap to the receptacle. In some examples, the applying the label or indicia to the receptacle occurs after the providing the contents in the receptacle (that is, the label or indicia is applied to the content-containing receptacle). In other examples, the applying the label or indicia to the receptacle occurs before or during the providing the contents in the receptacle. In some examples, the applying occurs before the closing. In some examples, the applying occurs after the closing. In some examples, the applying occurs during the closing.

According to a ninth aspect of the present invention there is provided use of a receptacle obtained by the method of manufacturing a receptacle according to any of the examples disclosed herein, to contain contents. The use could be, for example, by a person (such as a natural person or a company) who puts the contents into the receptacle, or by a person who transports the contents, or by a person who wishes to dispose of (e.g., to a consumer or end user), offer to dispose of (e.g., to a consumer or end user), import, or keep the contents whether for disposal or otherwise. The contents may, for example, be in the form of any of those discussed above. In some examples, the receptacle is a necked receptacle, such as a bottle, a jar or a type of vase. In some examples, the receptacle is a bottle.

It will be appreciated that optional features of aspects of the present invention may be equally applied to other aspects of the present invention, where appropriate.

### BRIEF DESCRIPTION OF DRAWINGS

Embodiments of the invention will now be described, by way of example only, with reference to the accompanying drawings, in which:

FIG. 1 is a schematic view of an example receptacle manufacturing line for performing a method of manufacturing receptacles from paper pulp;

FIG. 2 is a schematic diagram of an example of a moulding system according to an aspect of the invention;

FIGS. 3A-3D are side views of the moulding system of FIG. 2, taken at respective points in time as the transport system brings the hollow moulded fibre product into operative engagement with the mould for further moulding of the hollow moulded fibre product;

FIGS. 4A-4C are sectional views of an example moulding system, taken at respective points in time leading up to the further moulding of a hollow moulded fibre product;

FIG. 5 is a schematic diagram showing a further example of a moulding system, which comprises a primary mould for forming a hollow moulded fibre product from a fibre suspension, as well as a mould for further moulding such a hollow moulded fibre product;

FIG. 6 is a flow diagram that illustrates an example of a method of making a mould according to a further aspect of the invention;

FIG. 7 is a flow diagram that illustrates an example of a method of providing a processed hollow moulded fibre product according to a still further aspect of the invention;

FIG. 8 shows a non-transitory computer-readable storage medium according to an example;

FIG. 9 shows a schematic cross-sectional view of a receptacle containing contents, according to an example; and

FIG. 10 shows a method of providing a content-containing receptacle.

### DETAILED DESCRIPTION

The following description presents exemplary embodiments and, together with the drawings, serves to explain principles of embodiments of the invention.

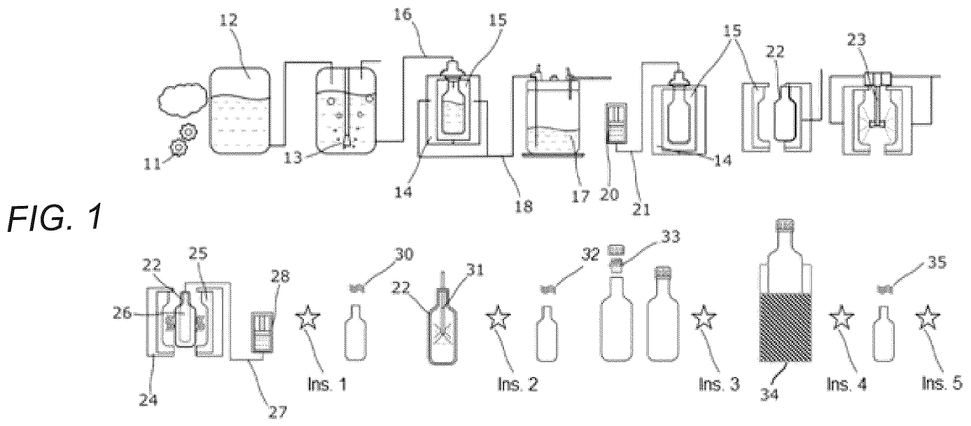

FIG. 1 shows a receptacle manufacturing line for performing a method of manufacturing receptacles, in this case necked receptacles, and more specifically in this case in the form of bottles, from paper pulp (i.e., which can form the basis of an example fibre suspension). By “necked receptacle” it is meant that the receptacle has an internal narrowing, or “neck”, between a main body portion, in which most of or all the contents of the receptacle are stored in use, and an opening through which the contents can enter or leave the receptacle in use. The internal width of the receptacle at the neck may be the same as or different to the internal width of the opening. However, the internal width of the neck is smaller than that of the main body portion, so that a shoulder is defined by and between the neck and the main body portion. This shoulder complicates manufacture of the receptacle, since it interferes with subsequent removal (and, in some cases, insertion) of whatever mould tool is inserted into the receptacle to form the internal shape of the receptacle. Examples of necked receptacles are bottles, jars, and certain types of vases. The process is merely exemplary and is provided to give context to examples of the present invention. It will be appreciated that, in other examples, the receptacle manufacturing line could be for making non-necked receptacles (i.e., receptacles without such a neck), such as bowls or trays.

Broadly speaking, the exemplary process comprises providing a fibre suspension, introducing the fibre suspension into a mould cavity of a porous first mould and expelling a liquid (such as water) from the fibre suspension to produce a hollow moulded fibre product (which may be called a wet precursor or embryo) in the mould cavity, further moulding the hollow moulded fibre product to produce a hollow further-moulded fibre product, drying and then internally-coating the hollow further-moulded fibre product to produce an internally coated product, drying the internally coated product to produce a dried product, applying a closure part to the dried product to produce a closable or closed product, externally-coating and/or decorating the closable or closed product to produce an externally coated and/or decorated product, and then drying the externally coated or decorated product to produce another dried product. As will be apparent at least from the following description, modifications may be made to the exemplary process to provide variants thereof in which other examples of the present invention may be embodied. For example, in some cases, either the internal coating or the external coating and/or decorating may be omitted. Moreover, in the present case and as indicated by the stars labelled Ins. 1 to Ins. 5 in FIG. 1, the process comprises inspecting or evaluating the hollow further-moulded fibre product, the internally coated product, the closable or closed product, the externally coated or decorated product, and the dried product to produce respective evaluated products. In some examples, the receptacle is the hollow moulded fibre product, the hollow further-moulded fibre product, the internally coated product, the closable or closed product, the externally coated or decorated product, one of the dried products, or one of the respective evaluated products.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. In this example, the liquid is mixed with the pulp fibres to provide hydrated pulp fibres having a solid fibres content of 1 wt % to 5 wt % (by dry mass of fibres). In examples, the one or more additives includes a sizing agent, such as alkylketene dimer (AKD). The hydrated pulp fibres typically comprise AKD in an amount of 0.4 wt % with respect to the total dry mass of the solid fibres in the hydrated pulp fibres. In some examples, one or more additives are present in the liquid at the point of mixing the pulp fibres with the liquid. In some examples, one or more additives are included in the hydrated pulp fibres after mixing the pulp fibres with the liquid (for example, the pulp fibres are hydrated for a period of time, such as from 2 to 16 hours, and then one or more additives are supplied to the hydrated pulp fibres). The hydrated pulp fibres are passed between plates of a valley beater 11 or refiner that are in motion relative to each other. This fibrillates some, or all, of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater 11 or refiner may be omitted.

The resultant processed pulp is stored in a vat 12 in a relatively concentrated form (for example, a solid fibres content of 1 wt % to 5 wt %) to reduce a required storage space. At an appropriate time, the processed pulp is transferred to a mixing station 13 at which the processed pulp is diluted in further water and, optionally, mixed with one or more additives (as well as, or in place of, the one or more additives provided with the hydrated pulp fibres) to provide the fibre suspension ready for moulding. In this example, the solid fibres account for 0.7 wt % of the resultant fibre suspension (by dry weight of fibres), but in other examples the proportion of solid fibres in the fibre suspension may be different, such as another value in the range of 0.5 wt % to 5 wt %, or 0.1 wt % to 1 wt %, of the fibre suspension (by dry weight of fibres).

In some examples, the one or more additives mixed with the processed pulp and water includes a dewatering agent, such as modified and/or unmodified polyethylene imine (PEI), for example modified PEI sold under the trade name Polymin® SK. In some examples, the one or more additives are mixed with the water, and the water and one or more additives subsequently mixed with the processed pulp; in other examples, the processed pulp and water are mixed, and the one or more additives subsequently mixed with the processed pulp and water. The fibre suspension typically comprises Polymin® SK in an amount of 0.3 wt % with respect to the total dry mass of the solid fibres. Mixing of the fibre suspension at the mixing station 13 helps to homogenise the fibre suspension. In other examples, the processed pulp or the fibre suspension may be provided in other ways, such as being supplied ready-made.

Downstream of the vat 12 and the mixing station 13 is a first moulding station that comprises a porous first mould 15. In this example, the porous first mould 15 comprises two half-moulds 14 that are movable towards and away from each other, in this case using a hydraulic ram. In this example, each of the half-moulds 14 is a monolithic or unitary tool formed by additive manufacturing (for example, 3D-printing) that defines a mould profile, and, when the half-moulds 14 are brought into contact with each other, their respective mould profiles cooperate to define the mould cavity in which the hollow moulded fibre product is to be formed. Each half-mould 14 itself defines a smaller moulding cavity and, when brought into cooperation with a second half-mould 14, the smaller moulding cavities combine to provide the overall mould cavity. The two half-moulds 14 may themselves be considered “splits” or “moulds” and the overall porous first mould 15 may be considered a “split-mould” or, again, a “mould”. In other examples, the porous first mould 15 may comprise more than two splits 14, such as three, four or six splits, that cooperate to define the moulding cavity.

In FIG. 1, the fibre suspension (also known as slurry) is top-filled into the porous first mould 15, in contrast to moulding processes that dip a mould in slurry. The fibre suspension is drawn under vacuum via a line 16 and into the porous first mould 15, with excess suspending liquid being drawn through the porous first mould 15 under vacuum via a line 18 into a tank 17. Shot mass may be controlled by measuring (for example, weighing) the amount of liquid drawn into the tank 17. A weight scale platform supporting the tank 17 is visible in FIG. 1. Once a required amount (for example, a predetermined volume, such as 10 litres, or a predetermined mass, such as 10 kilograms) of liquid has been collected in the tank 17, suction of the suspending liquid through the porous first mould 15 is stopped and the first mould 15 is opened to ambient air. In this example, the suspending liquid drawn with the fibre suspension in line 16 is water, or predominantly water (as additives may also be present). The liquid drawn under vacuum via the line 18 and into the tank 17 is substantially free of fibres, since these are left behind against the walls of the porous first mould 15 to form the hollow moulded fibre product.

In one example, in order to remove further suspending liquid (for example, water) from the hollow moulded fibre product, and form or consolidate the three-dimensional shape of the product, high pressure fluid (such as compressed air) is introduced into the first mould 15 to compress the fibre suspension against the cavity wall of the first mould 15. This process strengthens the product so that it can be handled, and displaces water from in between the fibres, thereby increasing the efficiency of a subsequent drying process. The fluid is regulated using a hydraulic pump 20. The pump 20 has a cylinder that displaces the fluid in a line 21 into the first mould 15. In an alternative example, an impermeable inflation element in the form of a collapsible bladder is inserted into the first mould 15 and expanded, by introduction of a fluid into the bladder from the line 21, to act as an internal high-pressure core structure for the first mould 15. In such an alternative, the fluid within the line 21 is preferably non-compressible, such as water or oil, although in other examples it could be a compressible fluid, such as air. Water has the advantage over other non-compressible liquids that any leaking or bursting of the bladder will not introduce a new substance to the system (since the suspending liquid is already water, or predominantly water).

Demoulding occurs when the first mould 15 opens for removal of the self-supporting hollow moulded fibre product 22. Mould cleaning 23 is preferably performed subsequently, to remove any remaining small fibres and/or other debris and maintain a porosity of the porous first mould 15. In this example, a radially firing high-pressure jet is inserted into the mould cavity while the first mould 15 is open. This dislodges debris from the wall of the mould cavity. Alternatively, or in addition, water from the tank 17 is pressurised through the back of the porous first mould 15 to dislodge entrapped fibres and/or other debris. Water is drained for recycling back to an upstream part of the system. It is noteworthy that cleaning is important for conditioning the first mould 15 for re-use. The first mould 15 may appear visibly clean after removal of the receptacle, but its performance could be compromised without cleaning.

According to FIG. 1, the hollow moulded fibre product 22 is subsequently transported to a second moulding station where, in a, for example, aluminium, mould 25, pressure and heat are applied for thermoforming a desired neck and surface finish, optionally including embossed and/or debossed surface features. After two halves of the mould 25 have closed around the product 22, a pressuriser is engaged. For example, a bladder 26 (for example, a thermoforming bladder 26) is inserted into the product 22. The bladder 26 is inflated with a pressurised fluid supplied via a line 27 by a pump 28. The pressurised fluid is preferably a non-compressible fluid such as water or oil, although in other examples it could be a compressible fluid such as air. In other examples, during supply, the pressurised fluid is heated with, for example, a heater or, alternatively, is cooled with, for example, a heat exchanger. An external mould block 24 of the mould 25, and/or the mould 25 itself, is also, or alternatively, heated in some examples. After thermoforming, a state of the product 22, which may now be considered a hollow further-moulded fibre product, is considerably more rigid, with more compressed side walls, as compared with the state of the product 22 at demoulding from the first mould 15.

A drying stage 30 (for example, a microwave drying process or other drying process) is performed on the product 22 downstream of the thermoforming, as shown, to provide a dried product. In one example, the drying stage 30 is performed before thermoforming to provide a dried product. However, moulding in the mould 25 requires some water content to assist with bonding during the compression process. The drying may be performed using a dryer, such as a machine that acts to cause drying of the product or simply a shelf or other support on which the product 22 rests while drying.

The product 22 is then subjected to an internal-coating stage during which, in this example, an interior coater in the form of a spray lance 31 is inserted into the product 22 and applies one or more surface coatings to internal walls of the product 22 to produce an internally coated product. In another example, the product 22 is instead filled with and subsequently drained of a liquid that coats the internal walls of the product 22. In practice, such coatings provide a protective layer to prevent egress of contents into the bottle wall, which may permeate and/or weaken it. Coatings will be selected dependent on the intended contents of finished receptacle, for example, a beverage, foodstuff, detergent, lubricant, pharmaceutical product, etc. In this example, the internally coated product 22 is then subjected to a curing or drying process 32, which can be configured or optimised dependent on the internal coating, for example, drying for twenty-four hours at ambient conditions or by a flash drying method. The drying again may be performed using a dryer, such as a machine that acts to cause drying of the product or simply a shelf or other support on which the product 22 rests while drying. Following the drying, the coated product 22 is considered another dried product.

A closure or mouth forming process is then performed on the product 22 by a closure-part applicator to produce a closable or closed product. For example, as shown in FIG. 1, a neck fitment 33 is affixed to the dried product. This results in the product being closable subsequently by positioning of a cap, lid or other closure relative to the neck fitment. An exterior coating and/or decoration is then applied to the product 22 by an exterior coater and/or a decorator, respectively, as shown in the further stage 34, to produce an externally coated and/or decorated product. In one example, the product 22 is dipped into a liquid to coat its outer surface, as shown in FIG. 1. In another example, the outer surface receives the external coating in a different manner. The coating and/or decoration may cover all or only part of an external surface of the product. The product 22 is then allowed to dry in warm air to produce another dried product. In other examples, the drying may be performed using a dryer such as one of those discussed above.

The product 22 may therefore be fully formed, considered the end “receptacle”, and ready to accept contents therein. In other examples, the receptacle may be fully formed without the neck fitment 35 being affixed and/or without the interior coating being applied and/or without the exterior coating being applied and/or without the decoration being applied and/or immediately after one of the drying processes or one of the inspecting and/or evaluating processes. For example, in some cases, the product is provided with the closure part by moulding the closure part during moulding of the product at the first moulding station and/or the second moulding station.

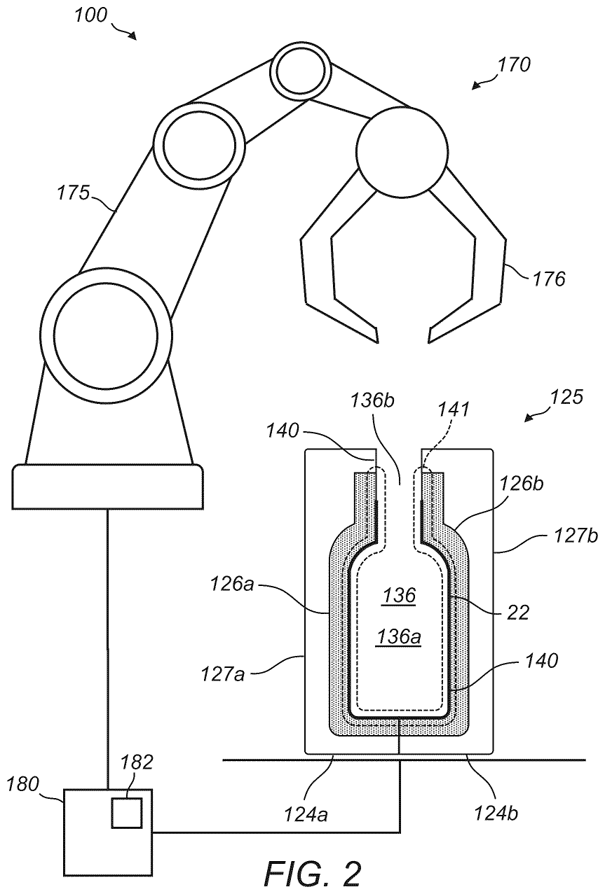

Reference is now directed to FIG. 2, which is a schematic diagram of a moulding system 100 for providing a processed hollow moulded fibre product according to an example embodiment of the invention.

As shown, the moulding system 100 comprises a mould 125, which is for further moulding a hollow moulded fibre product 22. The further moulding may, for example, achieve a desired neck and surface finish for the hollow moulded fibre product 22; for instance, the further moulding may form embossed and/or debossed surface features on the hollow moulded fibre product 22. The further moulding may also (or instead) increase the rigidity and/or robustness of the hollow moulded fibre product, for example by compacting the hollow moulded fibre product 22 and/or by removing liquid/moisture from it. As may therefore be appreciated, the moulding system 100 can form part of the receptacle manufacturing line described above with reference to FIG. 1, with the mould 125 taking the place of the mould 25 shown in FIG. 1.

As shown in FIG. 2, the mould 125 comprises a cavity 136, within which the hollow moulded fibre product 22 is further moulded, during use of the system 100. As also shown, the mould comprises several internal surfaces 140 that together define the cavity 136.

As indicated in FIG. 2, the internal surfaces 140 of the mould 125 comprise one or more porous regions 141. In the particular example shown, the porous regions 141 are provided by one or more pieces of porous material 126a, 126b (though this is not essential and in other examples the porous regions 141 could be provided by, for example, machining pores in non-porous material, e.g., by laser drilling). In the example shown, each porous region 141 is provided by a respective piece of porous material 126a, 126b (as shown in FIG. 2); however, in other examples, each porous region might be provided by plural pieces of porous material. As also shown, the cavity 136 is free from a net or mesh (though, again, this is by no means essential). Hence (or otherwise) the internal surfaces that define the cavity are generally smooth except for the presence of the plurality of pores.

As may be appreciated, the pieces of porous material 126a, 126b comprise a large number of pores, each having a circular cross-sectional shape in a plane orthogonal to a central axis of the pore, as is shown schematically in FIG. 2 by the dotted pattern on the pieces of porous material 126a, 126b. In particular, the pieces of porous material 126a, 126b provide a plurality of pores, each having a circular cross-sectional shape in a plane orthogonal to a central axis of the pore, that are distributed over the porous regions 141 of the internal surfaces 140 to provide continuous porosity over the porous regions 141. It is envisaged that these pores should have an average pore size (e.g., as measured at the internal surfaces 140) of less than or equal to 90 μm. The inventors consider that pores having an average pore size of less than or equal to 90 μm may provide a suitable quality level for the hollow moulded fibre product 22 after further moulding, including, for example, a relatively smooth surface on the hollow moulded fibre product 22. Moreover, where such pores are distributed over one or more porous regions 141 of the mould cavity 136 to provide continuous porosity over such porous regions 141, with such porous regions 141 extending over at least a majority of the total internal area of the mould cavity 136, such pores provide suitable venting of moisture and/or vapor from the cavity 136 to an exterior of the mould 125 during further moulding of the hollow moulded fibre product 22.

In some examples, to provide a relatively high level of venting of moisture and/or vapor from the cavity 136 to an exterior of the mould 125 during further moulding of the hollow moulded fibre product 22, the average pore size may be at least 10 μm.

To assist in providing continuous porosity over the one or more porous regions, the average spacing between adjacent pores 38 may, for example, be of the same order of magnitude as the average pore width (as defined at the corresponding internal surface 40 for each pore 38). Hence, in some examples, the average pore spacing may be less than or equal to 10 times the average pore width.

As will be appreciated given the small size of the pores of the porous regions 141 in comparison to common sizes of mould cavity 136 (which might, for example, be multiple centimetres wide and tall), there will, in many examples, be a very large number of pores (e.g., more than 1000, or more than 10,000) distributed over the porous regions 141 to assist in providing continuous porosity over the one or more porous regions 141.

As may also be appreciated, where the porous regions 141 are provided by one or more pieces of porous material 126a, 126b, the pores of the porous regions 141, which are disposed at the internal surfaces 140 of the cavity 136, may make up only a fraction of the pores comprised by the pieces of porous material 126a, 126b, given that the full complement of the pores comprised by a piece of porous material 126a, 126b will typically be distributed over the full volume of the piece of porous material 126a, 126b in question.

In many cases, the pores of each piece of porous material 126a, 126b that are not disposed at one of the internal surfaces 140 (and that do not, therefore, belong to a porous region 141) will have substantially the same average size as those that are. Put differently, each piece of porous material may be homogenous in terms of pore size. However, while such pieces of porous material may be more convenient to manufacture, this by no means essential and, in other examples, some or all of the pieces of porous material could, for instance, have pores that gradually increase (or decrease) in size from one side (or one end) of the piece of porous material to the other.

It should also be appreciated that each piece of porous material may, in addition or instead, be homogenous in terms of porosity. However, again, while such pieces of porous material may be more convenient to manufacture, this by no means essential.

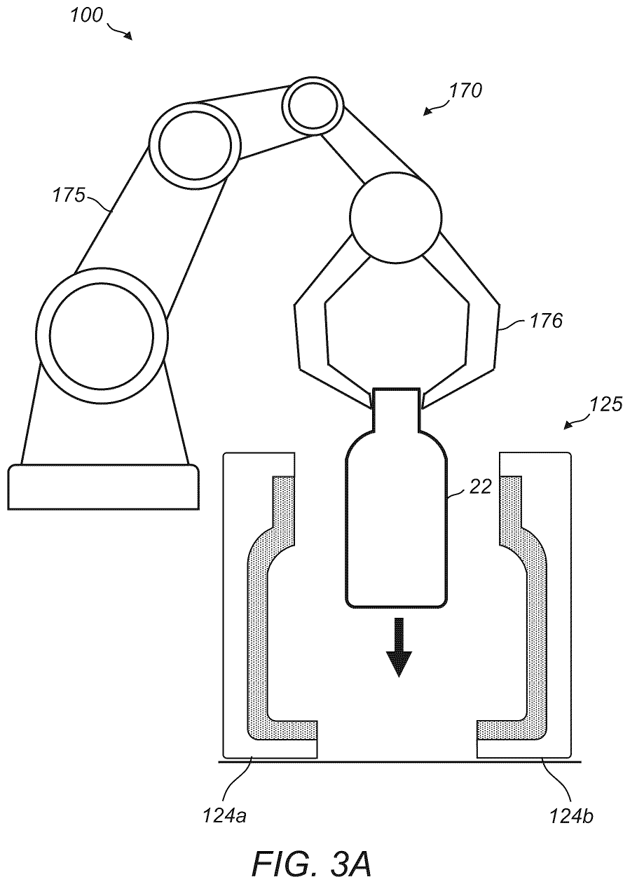

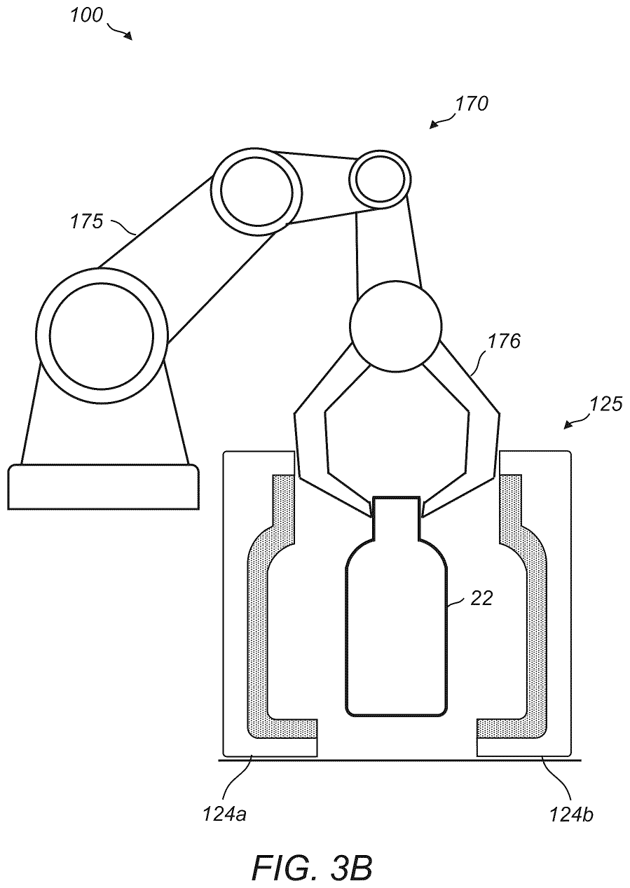

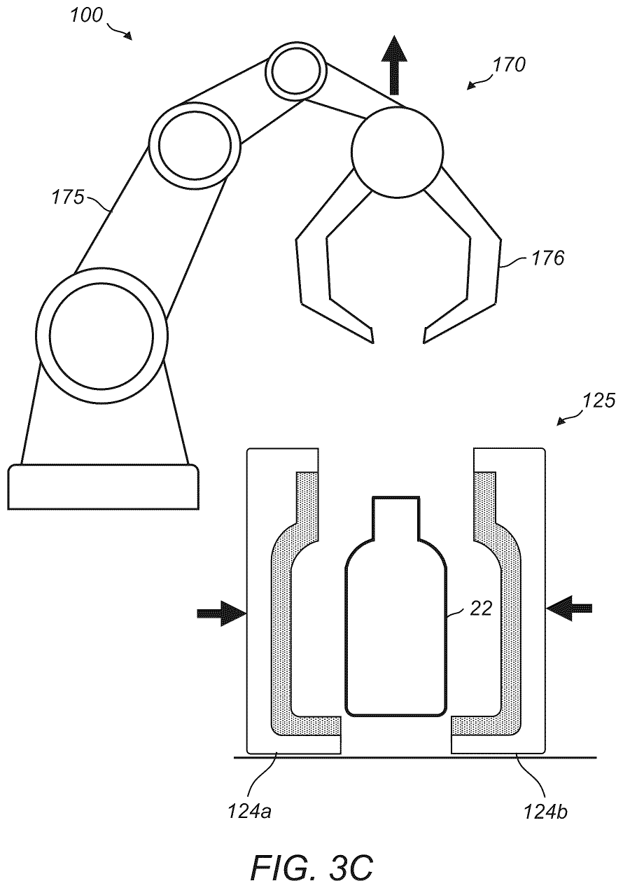

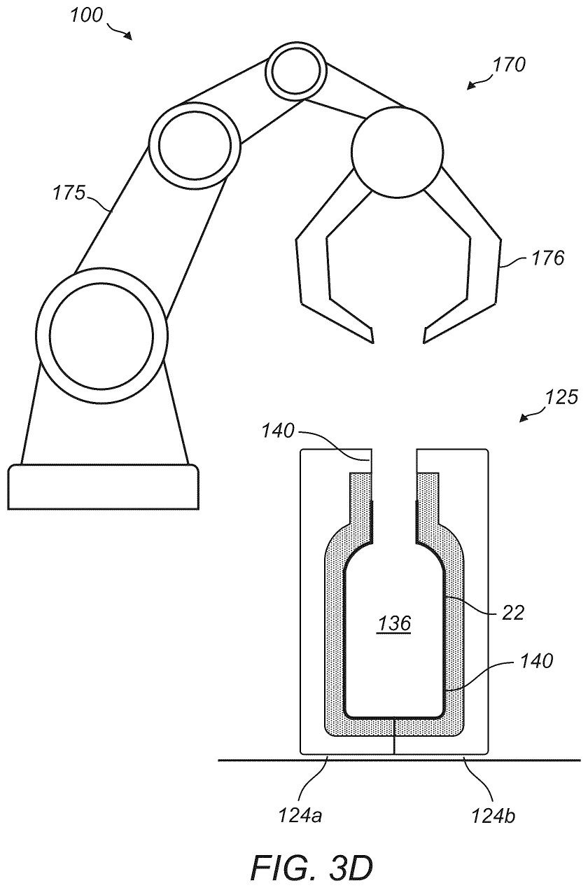

Returning to FIG. 2, also shown is a transport system 170, which forms a further part of the moulding system 100. The transport system 170 is configured to bring the hollow moulded fibre product 22 into operative engagement with the mould 125 for further moulding of the hollow moulded fibre product 22. For example, the transport system 170 may transport the hollow moulded fibre product 22 to a location where the mould 125 can close around the hollow moulded fibre product 22, as discussed below with reference to FIGS. 3A-3D.

Where the moulding system 100 forms part of the receptacle manufacturing line described above with reference to FIG. 1, with the mould 125 taking the place of the mould 25 shown in FIG. 1, the transport system 170 can be configured to collect the hollow moulded fibre product 22 from the primary mould 15 and to thereafter bring the hollow moulded fibre product 22 into operative engagement with the mould 125 for further moulding of the hollow moulded fibre product 22. However, this is by no means essential and in other examples the transport system 170 could be configured differently, for example to collect the hollow moulded fibre product 22 from a conveyor system or a storage container.

As shown in FIG. 2, the transport system 170 comprises a mechanical arm, specifically, a robotic arm 175. However, this is by no means essential and in other examples the transport system 170 might, for example, comprise a conveyor system with suitable fixtures to receive hollow moulded fibre products 22.

Where the transport system 170 does comprise a mechanical arm, such as a robotic arm 175, the arm may comprise a gripper 176 at an end thereof for grasping the hollow moulded fibre product 22, as illustrated in FIG. 2. However, this is by no means essential and the arm 175 may comprise various other suitable fixtures that allow it to grasp or hold the hollow moulded fibre product 22. Such fixtures might, for example, enlarge or expand within a neck or body portion of the hollow moulded fibre product 22, for instance by inflating an inflatable member within such a neck or body portion of the hollow moulded fibre product 22.

Referring once more to FIG. 2, it may be noted that in the particular example shown, the mould 125 is formed from two separate mould parts (or “splits”) 124a, 124b, similarly to the mould 25 shown in FIG. 1. However, this is by no means essential and in other examples the mould 125 could be formed of three, four etc. parts.

It may also be noted that, in the particular example shown in FIG. 2, each mould part 124a, 124b comprises a respective housing part 127a, 127b and a respective piece of porous material 126a, 126b, which is mounted on the corresponding housing part 127a, 127b. However, as may be appreciated from the discussion above, in other examples each housing part 127a, 127b could have plural pieces of porous material 126a, 126b mounted thereon. In examples, each housing part 127a, 127b may comprise channels (not shown) that provide fluid communication between the piece(s) of porous material mounted thereon and an exterior of the mould part 124a, 124b. Such channels may assist in removing fluid that is produced by the venting of moisture and/or vapor from the cavity 136 during further moulding of the hollow moulded fibre product 22.

In the illustrated example, the processed hollow moulded fibre product 22 (i.e., the further moulded hollow moulded fibre product 22) is, or will be (after further processing), a bottle. However, with suitable modifications to the system (e.g., to the shape of the cavity 136), the hollow moulded fibre product 22 can be, or can be used to make (with further processing) other kinds of receptacle, such as a jar or a type of vase, for example.

Referring once again to FIG. 2, also shown is a control system 180, which, in some examples, forms a further part of the moulding system 100. The control system 180 governs the operation of the moulding system 100 and, in particular, controls the mould 125 and the transport system 170 so as to provide a processed hollow moulded fibre product 22.

To facilitate such control, the control system 180 is in data or signal communication with the mould 125 and the transport system 170, as is indicated in FIG. 2 by the lines extending from control system 180. As also shown in FIG. 2, the control system 180 comprises at least one processor 182, which is suitably programmed to govern the operation of moulding system 100, for instance based on signals and/or data received from the mould 125 and the transport system 170.

Reference is directed next to FIGS. 3A-3D, which are side views of the moulding system 100 of FIG. 2, taken at respective points in time as the transport system 170 brings the hollow moulded fibre product 22 into operative engagement with the mould 125 for further moulding of the hollow moulded fibre product 22. It should be noted that this description is merely illustrative and concerns the functioning of the particular example of a moulding system 100 shown in FIG. 2; other examples may function quite differently, depending on the construction and arrangement of their moulds 125 and transport systems 170.

Turning first to FIG. 3A, the robotic arm 175 is shown holding the hollow moulded fibre product 22 with the gripper 176 and lowering the hollow moulded fibre product 22 into a location within the mould 125.

FIG. 3B shows the system 100 at a later time when the hollow moulded fibre product 22 is at the desired location within the mould 125. The gripper 176 then releases the hollow moulded fibre product 22, and, as shown in FIG. 3C, the robotic arm 175 moves away from the mould 125 and the mould parts 124a, 124b begin to move towards a closed arrangement. FIG. 3D shows the mould in the closed arrangement, with the hollow moulded fibre product 22 disposed within the cavity 136 of the mould 125.

As noted above, in the specific example illustrated in FIGS. 3A-3D, the transport system 170 is configured to bring the hollow moulded fibre product 22 into operative engagement with the mould 125 by moving the hollow moulded fibre product 22 to a location within the mould 125. Specifically, the hollow moulded fibre product 22 is moved to a location between the mould parts 124a, 124b of the mould 125. However, this is by no means essential and other kinds of operative engagement with the mould 125 may be appropriate with differently constructed moulds. Thus, in other examples the transport system 170 might be configured to move the hollow moulded fibre product 22 to a location at, on or in one of the mould parts 124a, 125b, or a location adjacent (rather than within) the mould 125.

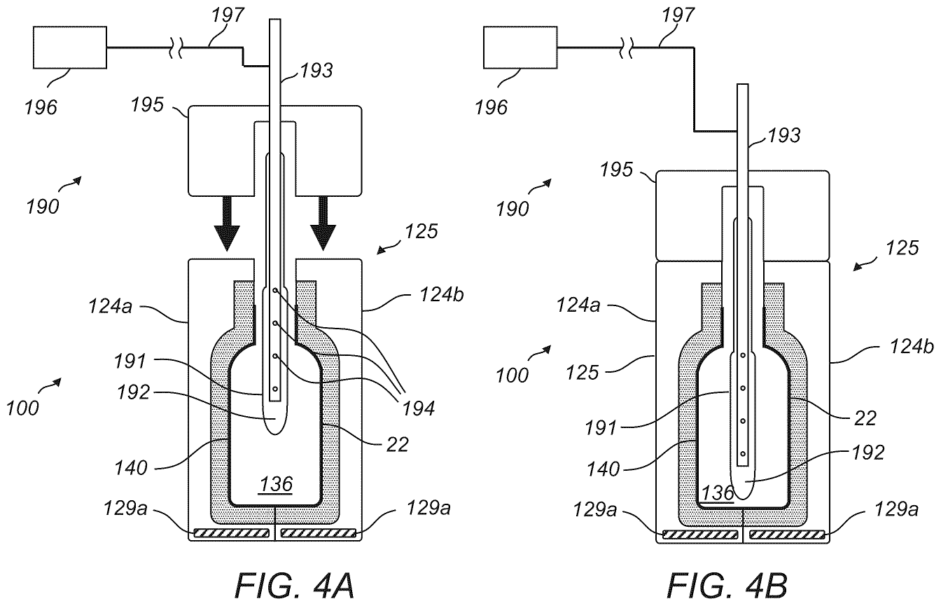

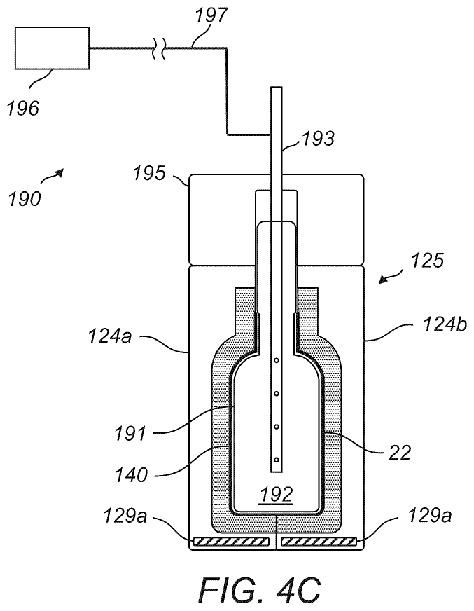

Reference is directed next to FIGS. 4A-4C, which are sectional views of the moulding system 100 shown in FIGS. 2-3D in which further components of the moulding system 100 are visible. The views of FIGS. 4A-4D are taken at respective points in time leading up to the further moulding of a hollow moulded fibre product 22.

Referring first to FIG. 4A, shown is a view of the moulding system 100 at a point in time prior to the further moulding of the hollow moulded fibre product 22. As shown in FIG. 4A, the moulding system 100 further comprises a pressuring system 190, which was not shown in FIGS. 2-3D for the sake of clarity. The pressuring system 190 is configured to apply pressure to an interior of the hollow moulded fibre product 22 during the further moulding of the hollow moulded fibre product 22 by the mould 125, so as to press an exterior of the hollow moulded fibre product 22 against the internal surfaces 140 of the mould 125. In examples, the pressuring system 190 is controllable so as to apply a specified amount of pressure to the interior of the hollow moulded fibre product 22.

As illustrated in FIGS. 4A-4C, the pressuring system 190 comprises an expandable element 191, which the pressuring system 190 is configured to expand during the further moulding of the hollow moulded fibre product 22 by the mould 125. In the particular example shown in FIGS. 4A-4C, the expandable element 191 is an inflation element 191. The expansion of the expandable element 191 causes an exterior of the inflation element 191 to be pressed against the interior of the hollow moulded fibre product, the pressuring system 190 thereby applying pressure to the interior of the hollow moulded fibre product 22. As a result, the exterior of the hollow moulded fibre product 22 is pressed against the one or more internal surfaces 140 of the mould 125. In this way, the pressuring system 190 assists in further moulding the hollow moulded fibre product 22.

As illustrated by the arrows in FIG. 4A, the pressuring system 190 may, in some examples, be operable to move the expandable element 191 relative to the mould 125 such that the expandable element 191 is inserted into the hollow moulded fibre product 22. However, in other examples, the mould 125 could be operable to move relative to the expandable element 191.

Reference is directed next to FIG. 4B, which shows the moulding system 100 at a later point in time, when the expandable element 191 of the pressuring system 190 has been fully inserted into the hollow mould fibre product 22. In the particular example shown, a connector 195 of the pressuring system 190 abuts the top of the mould 125 upon full insertion of the expandable element 191 into the mould 125, thus acting as a positive stop. However, the inclusion of such a connector is by no means essential and in other examples the pressuring system 190 could connect or engage with the mould 125 in any suitable manner.

Once the expandable element 191 has been fully inserted into the hollow moulded fibre product 22 and mould 125, the expandable element 191 is expanded. In the particular example shown, the expandable element 191 is an inflation element 191. Such an inflation element 191 may, for example, be expanded by introducing a fluid into the interior of the inflation element 191. In the particular example shown, this is accomplished by passing fluid along the interior of a tubular member 193 (or “mandrel”) that extends within the inflation member 191. This fluid exits the tubular member 193 through a series of holes 194 formed through the tubular member 193 and thereby enters a lumen 192 of the inflation element 191. The thus-expanded inflation element 191 is shown in FIG. 4C. In some examples, the fluid is one of air, water, or oil. The fluid may, for example, be forced along the interior of the tubular member 193 with the aid of a pump 196, which displaces fluid within a pump line 197 that is fluidically connected to the tubular member 193, as illustrated in FIGS. 4A-4C.

While in the particular example shown in FIGS. 4A-4C, the expandable element 191 is an inflation element 191, it should be appreciated that this is not essential. As will be understood, in other examples, the expandable element 191 could be expanded using various other approaches.

More generally, it should be appreciated that use of an expandable element 191 to apply pressure to the interior of the hollow moulded fibre product 22 and to thereby press the exterior of the hollow moulded fibre product 22 against the one or more internal surfaces 140 of the mould 125, is not essential. In other examples, the pressuring system 190 could apply pressure to the interior of the hollow moulded fibre product 22 in various other ways.

Returning to FIGS. 4A-4C, further shown is a heating system comprising multiple heaters 129a, 129b for heating the mould 125, in particular during the further moulding of the hollow moulded fibre product 22 by the mould 125. As may be appreciated, such heating of the mould 125 in turn heats the hollow moulded fibre product 22 (e.g., by conductive heat transfer). Heating the hollow moulded fibre product 22 during the further moulding thereof by the mould 125 may assist in removing fluid (for instance vapor or liquid, e.g., steam or water) from the hollow moulded fibre product 22, which may strengthen and/or stiffen the hollow moulded fibre product 22 and/or may smooth or otherwise improve the surface finish of the hollow moulded fibre product 22.

Although two heaters 129a, 129b are shown in FIGS. 4A-4C (one for each of the two mould parts 124a, 124b), it should be understood that the heating system might instead include only one heater, or might include three, four or more heaters, as appropriate.

More generally, while in the example shown in FIGS. 4A-4C, the heating system heats the mould to thereby heat the hollow moulded fibre product 22, in other examples the heating system might use a different approach to heat the hollow moulded fibre product 22. For example, the heating system might be configured to supply a heated fluid to the interior of the hollow moulded fibre product 22. In certain examples, the heated fluid might, for instance, contact the interior of the hollow moulded fibre product 22, whereas in other examples the heated fluid might be contained within an inflatable element (such as inflation element 191) that contacts the interior of the hollow moulded fibre product 22 to thereby transfer heat to the hollow moulded fibre product 22.

Still more generally, although FIGS. 4A-4C show a moulding system that includes both a heating system and a pressuring system, such systems can be implemented independently. Hence, it should be understood that heating systems according to any of the examples described above may be implemented independently of pressuring systems 190 according to any of the examples described above.

In terms of materials, the inventors consider that the mould 125 may suitably be formed from metallic materials, for example comprising aluminium, stainless steel or titanium. For instance, the mould may be formed at least in part from aluminium, aluminium alloy, or stainless steel, or from aluminium or stainless steel particles fused with a binder (e.g., a resin). In specific examples, the mould 125 may comprise aluminium in an amount that is at least 50%, by weight, of a total weight of the mould, or perhaps at least 60%, 70%, 80% or 90% by weight, or may comprise stainless steel in an amount that is at least 50%, by weight, of a total weight of the mould, or perhaps at least 60%, 70%, 80% or 90% by weight.

Furthermore, in examples, such as that shown in FIG. 2, where the porous regions 141 are provided by one or more pieces of porous material 126a, 126b, the porous material may comprise aluminium or stainless steel. For example the porous material may be porous aluminium or porous aluminium alloy, or porous stainless steel. In examples, the porosity of the porous material may be between about 10% and about 70% (inclusive).

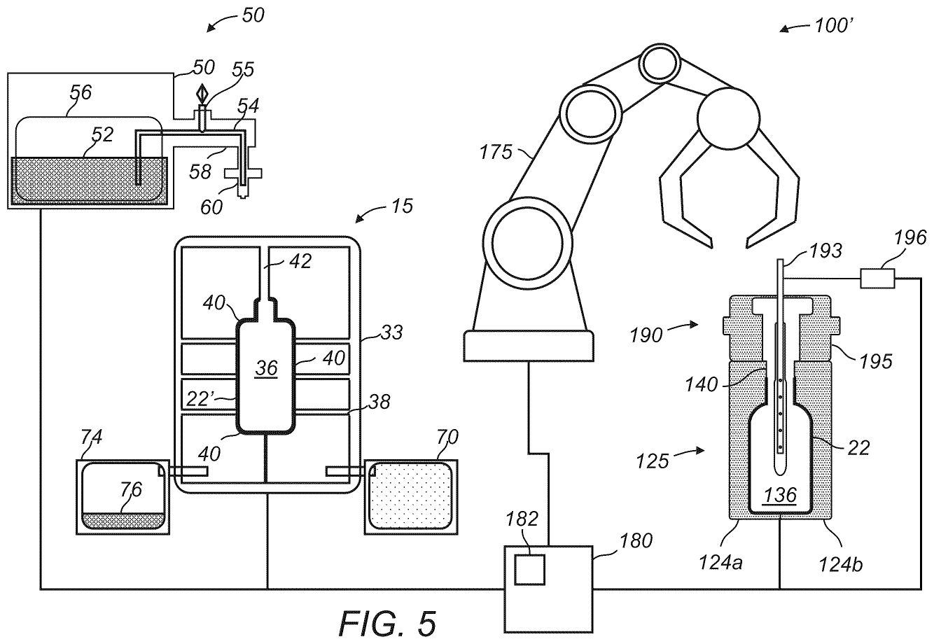

Reference is now directed to FIG. 5, which is a schematic diagram showing a further, more detailed example of a moulding system 100′. As shown, the moulding system 100′ comprises the mould 125 for further moulding a hollow moulded fibre product 22 described above with reference to FIGS. 2-4C and the pressuring system 190 described above with reference to FIGS. 4A-4C.

As also shown in FIG. 5, the moulding system 100 further comprises a primary mould 15, which is configured to form a hollow moulded fibre product 22 from a fibre suspension, and a fibre suspension supply system 50, which is configured to deposit a volume of the fibre suspension within the cavity 36 of the primary mould 15, so that the volume of the fibre suspension can be moulded by the cavity 36 of the primary mould 15 into a hollow moulded fibre product 22. In some examples, the primary mould 15 is the mould 15 described above with reference to FIG. 1.

FIG. 5 also shows a transport system 175, which forms a further part of the moulding system 100. The transport system 175 can incorporate any of the features of the transport system 175 described above with reference to FIGS. 2-3D. In the example shown in FIG. 5, the transport system 175 is configured to transport the hollow moulded fibre product 22 from the primary mould 15 into operative engagement with the mould 125 for further moulding the hollow moulded fibre product 22. Hence (or otherwise) the primary mould 15 may be described as being arranged “upstream” of the mould 125 for further moulding the hollow moulded fibre product 22. As may therefore be appreciated, the moulding system 100′ can form part of the receptacle manufacturing line described above with reference to FIG. 1, with the primary mould 15 taking the place of the mould 15 shown in FIG. 1, mould 125 taking the place of the mould 25 shown in FIG. 1. In addition, the fibre suspension supply system 50 can be used in place of mixing station 13 and line 16 to supply fibre suspension to the cavity of the primary mould 15.

Referring once again to FIG. 5, also shown is a control system 180, which, in some examples, forms a further part of the moulding system 100. The control system 180 governs the operation of the moulding system 100 and, in particular, controls the primary mould 15, the fibre suspension supply system 50, the mould 125 for further moulding the hollow moulded fibre product 22, and the transport system 170, so as to provide a processed hollow moulded fibre product 22.

To facilitate such control, the control system 180 is in data or signal communication with the primary mould 15, the fibre suspension supply system 50, the mould 125 for further moulding the hollow moulded fibre product 22, the transport system 170, and the pressuring system 190, as is indicated in FIG. 5 by the lines extending from control system 180. As also shown in FIG. 5, the control system 180 comprises at least one processor 182, which is suitably programmed to govern the operation of moulding system 100, for instance based on signals and/or data received from the primary mould 15, the fibre suspension supply system 50, the mould 125 for further moulding the hollow moulded fibre product 22, the transport system 170, and the pressuring system 190.

Various exemplary features of the fibre suspension supply system 50 are also shown in FIG. 5. These features are described and shown solely for the purposes of illustration and are not considered essential. Referring to FIG. 5, the exemplary fibre suspension supply system 50 comprises a tank 56 which temporarily contains the fibre suspension 52 before it is introduced into the primary mould 15. The fibre suspension supply system 50 may, for example, be used along with the mixing station 13 of FIG. 1, or the mixing capabilities of the mixing station 13 could be performed by the fibre suspension supply system 50 itself. The fibre suspension supply system 50 of this example also comprises a line 54 along which the fibre suspension 52 can flow from the tank 56 and into the primary mould 15. The fibre suspension supply system 50 additionally comprises an arm 58 and a connecting portion 60. The line 54 runs through the arm 58 and into the connecting portion 60. The fibre suspension 52 exits the fibre suspension application system 50 and enters the mould 15 via the connecting portion 60 and an opening 42 in the mould 15 that opens into the cavity 36. In some examples, the connecting portion 60 is shaped to cooperate with the top of the mould 15 and/or the block 33 which contains the mould.

As noted above, these specific features of the fibre suspension supply system 50 are merely exemplary; the fibre suspension supply system 50 could be constructed in a wide variety of ways in order to supply fibre suspension(s) to the cavity 36 of the mould 15. For example, fibre suspension supply system 50 may deposit fibre suspension(s) within the cavity 36 of the mould 15 by spraying fibre suspension(s) within the cavity 36, by pouring fibre suspension(s) into the cavity 36, or by dipping the mould 15 into fibre suspension(s). As will be appreciated, different constructions of the fibre suspension supply system 50 will be suitable for different constructions of the mould 15 (and vice versa).

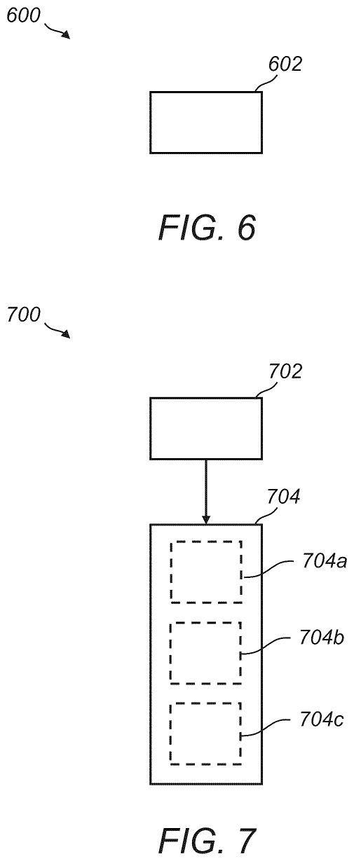

Although, for the sake of simplicity, the control systems 180 shown in FIGS. 2 and 6 are illustrated with a single box, it should be understood that such control systems 180 need not be physically or functionally unitary. In particular, components of the control system 180 need not be co-located. Hence, in some embodiments, some or all of the components of the control system 180 may be integrated within other (sub) systems within the overall moulding system 100. Additionally, it is not essential that processing resources of the control system 180 be centralized; to the contrary, processing may be distributed amongst a number of processors that might, for example, be integrated within the various other (sub) systems within the overall moulding system 100.

Reference is now directed to FIG. 6, which is a flow diagram that illustrates an example of a method 600 of making a mould according to a further aspect of the invention. The mould in question is for further moulding a hollow moulded fibre product that has been brought into operative engagement with the mould by a transport system and may therefore incorporate features of the mould 125 described above with reference to FIGS. 2-5. As shown in FIG. 6, the method 600 comprises forming 602, in one or more pieces, a mould comprising: one or more internal surfaces that together define a cavity, in which the further moulding of the receptacle is carried out during use of the mould, the cavity having a total internal area, the one or more internal surfaces comprising one or more porous regions that extend over at least a majority of the total internal area; and a plurality of pores (each having, e.g., a circular cross-sectional shape in a plane orthogonal to a central axis of the pore), the pores being distributed over the one or more porous regions to provide continuous porosity over the one or more porous regions, the pores having an average pore size of less than or equal to 90 μm. For example, a mould 125 as described above with reference to FIGS. 2-5 may be formed in block 602. In a specific example, each of the pieces of porous material 126a, 126b may be a corresponding one of the pieces formed in block 602.

In examples, block 602 comprises additively manufacturing at least some of the one or more pieces formed in block 602. Additive manufacturing may, for example, afford suitably accurate formation of the features of the mould, for example features of the interior surfaces thereof. The additive manufacturing carried out as part of block 602 may, for example, comprise sintering particulate matter. In particular, the particulate matter may be sintered to an extent such that pores remain between particles of the particulate matter that can provide (at least in part) the plurality of pores that are distributed over the porous regions of the mould. In examples, the additive manufacturing may utilise a powder bed fusion technique, such as Direct Metal Laser Sintering (DMLS), Electron Beam Melting (EBM), or Selective Laser Melting (SLM). The particulate material may suitably be metallic, for example it may be a metal or metal alloy. As an alternative to powder bed fusion, a powder adhesion technique may be used, for instance with metallic powder.

It is, however, by no means essential that the one or more mould pieces are formed by additive manufacturing. Accordingly, block 602 may alternatively (or in addition) comprise machining at least one piece of a porous material, for instance a porous metallic material, such as porous aluminium. (As used herein, machining refers to the use of a subtractive manufacturing process, i.e., a process that involves the removal of material.) Such machining may be under the control of a computer; for example, a CNC machine may be used.

Reference is now directed to FIG. 7, which is a flow diagram that illustrates an example of a method 700 of providing a processed hollow moulded fibre product according to a still further aspect of the invention. As shown, the method 700 comprises, at block 702, introducing a hollow moulded fibre product into a mould, the mould comprising: one or more internal surfaces that together define a cavity having a total internal area, the one or more internal surfaces comprising one or more porous regions that extend over at least a majority of the total internal area; a plurality of pores (each having, e.g., a circular cross-sectional shape in a plane orthogonal to a central axis of the pore), the pores being distributed over the one or more porous regions to provide continuous porosity over the one or more porous regions, the pores having an average pore size of less than or equal to 90 μm. For example, a mould 125 as described above with reference to FIGS. 2-5 may be used in block 702.

As shown in FIG. 7, the method 700 further comprises, at block 704, further moulding the hollow moulded fibre product within the cavity of the mould so as to provide the processed hollow moulded fibre product. In examples, the further moulding of the hollow moulded fibre product of block 704 comprises at least one of:
moving 704a the mould into a closed arrangement with the hollow moulded fibre product within the cavity of the mould (for example as described above with reference to FIGS. 3C and 3D); and
pressing 704b an exterior of the hollow moulded fibre product against the one or more internal surfaces of the mould.

In examples where the further moulding of the hollow moulded fibre product of block 704 comprises pressing 704b an exterior of the hollow moulded fibre product against the one or more internal surfaces of the mould, during the pressing 704b of the exterior of the hollow moulded fibre product against the one or more internal surfaces of the mould, fluid (such as vapor or liquid, e.g., steam or water) leaves the cavity of the mould through the plurality of pores. The fluid may thereafter pass through and out of the mould, via an exterior surface thereof.

In some examples where the further moulding of the hollow moulded fibre product of block 704 comprises pressing 704b an exterior of the hollow moulded fibre product against the one or more internal surfaces of the mould, the pressing 704b of block 704 of the exterior of the hollow moulded fibre product against the one or more internal surfaces of the mould comprises applying pressure to the interior of the hollow moulded fibre product. In particular examples, the applying pressure to the interior of the hollow moulded fibre product comprises expanding an inflation element, so that an exterior of the inflation element is pressed against the interior of the hollow moulded fibre product.

In some examples, the further moulding of the hollow moulded fibre product of block 704 comprises heating 704c the hollow moulded fibre product. For instance, the heating 704c of the hollow moulded fibre product may comprise heating the mould (so that, for example, the mould, in turn, heats the hollow moulded fibre product, e.g., by conductive heat transfer). Alternatively (or additionally), the heating 704c of the hollow moulded fibre product may comprise introducing a heated fluid to the interior of the hollow moulded fibre product. In some cases, the heated fluid will be in direct contact with the internal surfaces of the hollow moulded fibre product. However, in other cases, the heated fluid may be introduced into a vessel located within the interior of the hollow moulded fibre product. For example, the heated fluid might be introduced into an inflation element that is located within the interior of the hollow moulded fibre product. The expansion of such an inflation element may cause an exterior of the inflation element to be pressed against the interior of the hollow moulded fibre product, so as to assist in the pressing 704b of the exterior of the hollow moulded fibre product against the one or more internal surfaces of the mould. More generally, where the further moulding of the hollow moulded fibre product of block 704 comprises pressing 704b an exterior of the hollow moulded fibre product against the one or more internal surfaces of the mould, heating 704c of the hollow moulded fibre product according to any of the examples described above may occur during the pressing 704b of the exterior of the hollow moulded fibre product against the one or more internal surfaces of the mould block.

It will be appreciated that there is provided a control system 180 that is configured to cause a mould (such as the example moulds 125, 125′ described above with reference to FIGS. 2-5) to provide a processed hollow moulded fibre product. Also provided is a control system 180 that is configured to cause a moulding system (such as the example moulding systems 100, 100′ described above with reference to FIGS. 2-5) to provide a processed hollow moulded fibre product.

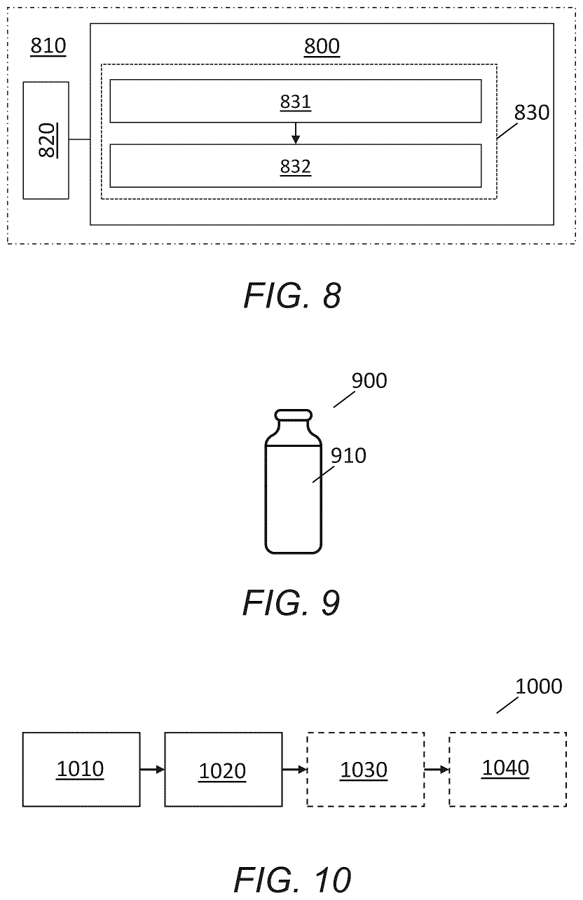

FIG. 8 shows a schematic diagram of a non-transitory computer-readable storage medium 800 according to an example. The non-transitory computer-readable storage medium 800 stores instructions 830 that, if executed by a processor 820 of a control system 810, cause the processor 820 to perform a method according to an example described herein. In some examples, the control system 810 is or comprises the control system 180 as described above. The instructions 830 comprise:

an instruction 831 to introduce a hollow moulded fibre product into a mould, the mould comprising: one or more internal surfaces that together define a cavity having a total internal area, the one or more internal surfaces comprising one or more porous regions that extend over at least a majority of the total internal area; and a plurality of pores (each having, e.g., a circular cross-sectional shape in a plane orthogonal to a central axis of the pore), the pores being distributed over the one or more porous regions to provide continuous porosity over the one or more porous regions, the pores having an average pore size of less than or equal to 90 μm; and

an instruction 832 to further mould the hollow moulded fibre product within the cavity of the mould so as to provide the processed hollow moulded fibre product.

In other examples, the instructions 830 comprise instructions to perform any of the other example methods described herein. For instance, the instructions 830 may comprise an instruction to move the mould into a closed arrangement with the hollow moulded fibre product within the cavity of the mould, as part of the further moulding of the hollow moulded fibre product in accordance with instruction 832. Additionally, or alternatively, the instructions 830 may comprise an instruction to press an exterior of the hollow moulded fibre product against the one or more internal surfaces of the mould, as part of the further moulding of the hollow moulded fibre product according to instruction 832.

It will also be appreciated that there also is provided a receptacle manufacturing line (such as that shown in FIG. 1) comprising a moulding system (for example as described above with reference to FIGS. 2-5) for providing a processed hollow moulded fibre product and apparatus for performing at least one additional process on the processed hollow moulded fibre product to provide the receptacle. Similarly, also provided is a method of manufacturing a receptacle, the method comprising performing a method of providing a processed hollow moulded fibre product (for example as described above with reference to FIG. 7), and then performing at least one additional process on the processed hollow moulded fibre product to provide the receptacle. Examples of the “at least one additional process” are described above with reference to FIG. 1.

Also provided, as a result of the content of the present application, is use of a receptacle obtained by any of the methods described herein to contain contents. An example such receptacle 900, in the form of a necked receptacle and specifically a bottle, containing contents 910 is shown in FIG. 9. The use could be, for example, by a person who puts the contents into the receptacle, by a person who transports the contents, or by a person who wishes to dispose of (for example, to a consumer or end user), offer to dispose of (for example, to a consumer or end user), import, or keep the contents whether for disposal or otherwise. The contents could, for example, be any one or more of the example contents described herein.

Also provided is a method of providing a content-containing receptacle. An example such method 1000 is shown in FIG. 10. The method 1000 comprises providing 1010 the receptacle, in the form of a necked receptacle and specifically a bottle, and then providing 1020 the contents in the receptacle. In this example, block 1020 follows block 1010, so that block 1020 comprises putting the contents into the receptacle that has been provided at block 1010. However, in some other examples, blocks 1010 and 1020 are performed concurrently, so that the providing 1010 the receptacle comprises providing the receptacle with the contents already present in the receptacle. The contents could, for example, be any one or more of the example contents described herein. The method 1000 also comprises closing 1030 an opening of the receptacle after block 1020, and applying 1040 a label or indicia to the receptacle after block 1030. In this example, block 1030 involves applying a heat seal to the opening and then screwing a cap or lid onto the receptacle, and block 1040 comprises adhering a label onto the receptacle.

In respective other examples, the order of blocks 1030 and 1040 is reversed, blocks 1030 and 1040 are performed concurrently, block 1030 is omitted, and block 1040 is omitted. In some examples, block 1040 occurs before block 1020, or block 1040 occurs during block 1020. For example, in some cases, the label or indicia is applied to the receptacle, then the contents are provided in the receptacle, and then the receptacle is closed.

It will be appreciated that the method 1000 could be performed by the same party that manufactures the receptacle, for example so that block 1010 comprises the method discussed above with reference to the manufacturing line shown in FIG. 1. Alternatively, the method 1000 could be performed by a different party to that which manufactures the receptacle. In such an alternative, the different party performs block 1010 by way of obtaining the receptacle from the party that manufactures the receptacle (such as by way of the method discussed above with reference to FIG. 1) or from an intermediary.

Example embodiments of the present invention have been discussed, with reference to the examples illustrated. However, it will be appreciated that variations and modifications may be made without departing from the scope of the invention as defined by the appended claims.

What is claimed is:

1. A moulding system for providing a processed hollow moulded fibre product, the system comprising:
a mould for further moulding a hollow moulded fibre product to provide the processed hollow moulded fibre product, the mould comprising:
one or more internal surfaces that together define a cavity, within which the further moulding of the hollow moulded fibre product is carried out, during use of the system, the cavity having a total internal area and the one or more internal surfaces comprising one or more porous regions that extend over at least a majority of the total internal area;
a plurality of pores, the pores being distributed over the one or more porous regions to provide continuous porosity over the one or more porous regions, the pores having an average pore size of less than or equal to 90 μm; and
a transport system configured to bring the hollow moulded fibre product into operative engagement with the mould for the further moulding.

2. The moulding system of claim 1, further comprising:
a primary mould comprising a cavity; and
a fibre suspension supply system, which is configured to deposit a volume of the fibre suspension within the cavity of the primary mould, so that the volume of the fibre suspension is thereby mouldable by the cavity of the primary mould into the hollow moulded fibre product.

3. The moulding system of claim 1, further comprising a heating system for heating the hollow moulded fibre product during the further moulding of the hollow moulded fibre product by the mould.

4. The moulding system of claim 1, further comprising a pressuring system for applying pressure to an interior of the hollow moulded fibre product during the further moulding of the hollow moulded fibre product by the mould, so as to press an exterior of the hollow moulded fibre product against the one or more internal surfaces of the mould.

5. A method of providing a processed hollow moulded fibre product, the method comprising:
introducing a hollow moulded fibre product into a mould, the mould comprising:
one or more internal surfaces that together define a cavity having a total internal area, the one or more internal surfaces comprising one or more porous regions that extend over at least a majority of the total internal area;
a plurality of pores, the pores being distributed over the one or more porous regions to provide continuous porosity over the one or more porous regions, the pores having an average pore size of less than or equal to 90 μm; and
further moulding the hollow moulded fibre product within the cavity of the mould so as to provide the processed hollow moulded fibre product.

6. The method of claim 5, wherein the further moulding the hollow moulded fibre product within the cavity of the mould comprises pressing an exterior of the hollow moulded fibre product against the one or more internal surfaces of the mould; and heating the hollow moulded fibre product.

7. A mould for further moulding a hollow moulded fibre product that has been brought into operative engagement with the mould by a transport system, to provide a processed hollow moulded fibre product, the mould comprising:
one or more internal surfaces that together define a cavity, in which the further moulding of the hollow moulded fibre product is carried out during use of the mould, the cavity having a total internal area, the one or more internal surfaces comprising one or more porous regions that extend over at least a majority of the total internal area; and
a plurality of pores, the pores being distributed over the one or more porous regions to provide continuous porosity over the one or more porous regions, the pores having an average pore size of less than or equal to 90 μm.

8. A method of making a mould for further moulding a hollow moulded fibre product that has been brought into operative engagement with the mould by a transport system, the mould comprising:
one or more internal surfaces that together define a cavity, in which the further moulding of the hollow moulded fibre product is carried out during use of the mould, the cavity having a total internal area, the one or more internal surfaces comprising one or more porous regions that extend over at least a majority of the total internal area; and
a plurality of pores, the pores being distributed over the one or more porous regions to provide continuous porosity over the one or more porous regions, the pores having an average pore size of less than or equal to 90 μm,
the method comprising:
forming the mould in one or more pieces.

9. The moulding system of claim 1, wherein the average pore size is less than or equal to 50 μm.

10. The moulding system of claim 1, wherein the average pore size is greater than or equal to 10 μm.

11. The moulding system of claim 1, wherein the mould for further moulding the hollow moulded fibre product comprises aluminium in an amount that is at least 50%, by weight, of a total weight of the mould.

12. The moulding system of claim 1, wherein the mould for further moulding the hollow moulded fibre product comprises stainless steel in an amount that is at least 50%, by weight, of a total weight of the mould.

13. The moulding system claim 1, wherein each of the pores has a circular cross-sectional shape in a plane orthogonal to a central axis of the pore.

14. A control system configured to cause a moulding system to perform the method of providing a processed hollow moulded fibre product of claim 5.

15. A non-transitory storage medium storing machine-readable instructions that, when executed by a processor of a controller for a moulding system, cause the moulding system to perform the method of providing a processed hollow moulded fibre product of claim 5.

16. A receptacle manufacturing line comprising the moulding system of claim 1 for providing the processed hollow moulded fibre product and apparatus for performing at least one additional process on the processed hollow moulded fibre product to provide the receptacle.

17. A receptacle produced by the process comprising:
introducing a hollow moulded fibre product into a mould, the mould comprising:
one or more internal surfaces that together define a cavity having a total internal area, the one or more internal surfaces comprising one or more porous regions that extend over at least a majority of the total internal area;
a plurality of pores, the pores being distributed over the one or more porous regions to provide continuous porosity over the one or more porous regions, the pores having an average pore size of less than or equal to 90 μm; and
further moulding the hollow moulded fibre product within the cavity of the mould so as to provide the processed hollow moulded fibre product.
